(19) United States
(12) Patent Application Publication
(10) Pub. No.: US 2022/0404271 A1
(43) Pub. Date: Dec. 22, 2022

(54) Airborne Remote Sensing with Towed Sensor Units

(71) Applicant: Mesos LLC, Houston, TX (US)

(72) Inventors: Robert Kendall, Houston, TX (US); Roelof Jonkman, Mill Valley, CA (US)

(73) Assignee: Mesos LLC, Houston, TX (US)

(21) Appl. No.: 17/808,067

(22) Filed: Jun. 21, 2022

Related U.S. Application Data
(60) Provisional application No. 63/202,703, filed on Jun. 21, 2021.

(51) Int. Cl. G01N 21/3504; G01M 3/38; B64C 39/02

(52) U.S. Cl. CPC G01N 21/3504; G01M 3/38; B64C 39/024; B64C 2201/127

(57) ABSTRACT

A system for airborne remote sensing comprises an array of remote sensing devices configured for being towed by an aircraft. Each of the array of remote sensing devices is configured for lateral separation in flight, to provide a large coverage area than any of the array of remote sensing devices can cover by itself. Onboard electronics comprise sensors, such as a forward imaging infrared camera for capturing data in flight. By analyzing the data collected by the remote sensing system, various types of information can be generated, such as hydrocarbon leak detection.

### CROSS-REFERENCE TO RELATED APPLICATION

This patent application claims priority to U.S. Provisional Patent Application No. 63/202,703, filed on Jun. 21, 2021, and entitled “AIRBORNE REMOTE SENSING WITH TOWED SENSOR UNITS.” The disclosure of the prior application is considered part of and is incorporated by reference into this patent application.

### TECHNICAL FIELD

The present invention relates to the field of remote sensing, and in particular to a system and technique for airborne remote sensing using an array of towed sensor units.

### BACKGROUND ART

A need to reduce methane and other greenhouse gas (GHG) emissions has driven the development of innovative solutions for remote sensing of GHG emissions. Significant efforts have been put into attempts to find cost-effective technologies that could help companies find and manage emissions in a faster, more efficient way. To date, however, leak detection technology has remained slower and more expensive than would be desirable, limiting the ability to find and manage those undesirable emissions.

### SUMMARY OF INVENTION

In one general aspect, a remote sensing system for towing by a towing aircraft may include: an array of remote sensing devices, connected by cables, wherein each remote sensing device of the array of remote sensing devices may include: a fuselage; an electronics package configured for remote sensing disposed with the fuselage, including: an imaging sensor; and means for capturing images sensed by the imaging sensor; and means for controlling inflight separation of each remote sensing device of the array of remote sensing devices from other remote sensing devices of the array of remote sensing devices; and means for coupling the array of remote sensing devices to the towing aircraft.

In another general aspect, a method of remote sensing may include: provisioning a plurality of towable remote sensing devices, including: provisioning an imaging sensor in each of the plurality of towable remote sensing devices; provisioning an image capture system in each of the plurality of towable remote sensing devices configured to capture images sensed by the imaging sensor; connecting the plurality of towable remote sensing devices as an array of towable remote sensing devices; controlling inflight separation of the array of towable remote sensing devices from each other; coupling the array of towable remote sensing devices to a towing aircraft; and towing the array of towable remote sensing devices over a designated surveillance area by the towing aircraft.

### BRIEF DESCRIPTION OF DRAWINGS

The accompanying drawings, which are incorporated in and constitute a part of this specification, illustrate an implementation of apparatus and methods consistent with the present invention and, together with the detailed description, serve to explain advantages and principles consistent with the invention. In the drawings,

FIG. 1 is a block drawing illustrating a remote sensing aircraft towing an array of remote sensing devices according to one embodiment.

FIG. 2 is a block drawing illustrating vertical spacing of a towed array of remote sensing devices according to one embodiment.

FIG. 3 is a block diagram illustrating a pickup technique for initiating a tow of an array of remote sensing devices according to one embodiment.

FIG. 4 is a block diagram illustrating a towable remote sensing device according to one embodiment.

FIG. 5 is a block diagram illustrating electronic components for mounting in a fuselage of a towable remote sensing device according to one embodiment.

FIG. 6 is a flowchart illustrating a process for remote sensing according to one embodiment.

### DESCRIPTION OF EMBODIMENTS

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form to avoid obscuring the invention. References to numbers without subscripts are understood to reference all instances of subscripts corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

Although some of the following description is written in terms that relate to software or firmware, embodiments can implement the features and functionality described herein in software, firmware, or hardware as desired, including any combination of software, firmware, and hardware. References to daemons, drivers, engines, modules, or routines should not be considered as suggesting a limitation of the embodiment to any type of implementation.

Various types of remote sensing methods have been used to date. Various parties have used piloted satellites, drones, trucks, airplanes, and combinations of those systems. Drones require a skilled drone pilot to travel from place to place, launch the drone and pilot it in the air, then recover the drone. The data collected by the drone must then be downloaded and analyzed. Because the types of drones used in such a system have significantly limited flight time limitations, the area that can be examined by a drone in a single flight is necessarily also significantly limited. In addition, the cost of hiring a drone pilot and transporting the drone pilot from place to place is significant.

Truck-mounted sensing systems are simpler, typically requiring only a truck driver with sufficient training to operate the truck-mounted sensing equipment. However, the range of truck-mounted sensing equipment is low, the truck is typically limited to areas with good roads, and the time required to drive the truck from site to site can be extensive.

Satellite-based remote sensing systems are highly expensive, with significant infrastructure required to manage the satellite while in orbit. Although satellite remote sensing systems have increased their capabilities since the earliest Landsat satellites were launched in the 1970s, the resolution of remote sensing satellites with a high revisit rate is still larger than desired, while remote sensing satellites with a better resolution rate typically have a prohibitively low revisit rate.

Airplanes providing aerial surveillance have been in use for decades and can provide high-resolution sensing capability. However, a single airplane equipped with sensing equipment can cover a limited area at any time, and the cost of the airplane and skilled pilot are high.

The desired approach is to get high-resolution sensing of large designated surveillance areas at the lowest possible cost. In one embodiment, a remote sensing system uses a single piloted aircraft that can tow an array of sensing devices, expanding the coverage area at a lower cost than multiple remote sensing piloted aircraft.

The remote sensing aircraft is preferably a piloted aircraft capable of flying low and slow over a target area. Thus, airplanes of the type used for crop dusting or aerial advertising are a good match for a remote sensing piloted airplane. The most common agricultural aircraft are fixed-wing aircraft such as the Air Tractor®, the Cessna® Ag-wagon, and the Thrush®, but helicopters can also be used. (AIR TRACTOR is a registered trademark of Air Tractor, Inc.; CESSNA is a registered trademark of Textron Aviation, Inc.; THRUSH is a registered trademark of Thrush Aircraft, Inc.) Most such aircraft have piston or turboprop engines, although jet engines could be used. The same or similar types of aircraft are used for aerial advertising and an aerial advertising airplane could be used for remote sensing operations.

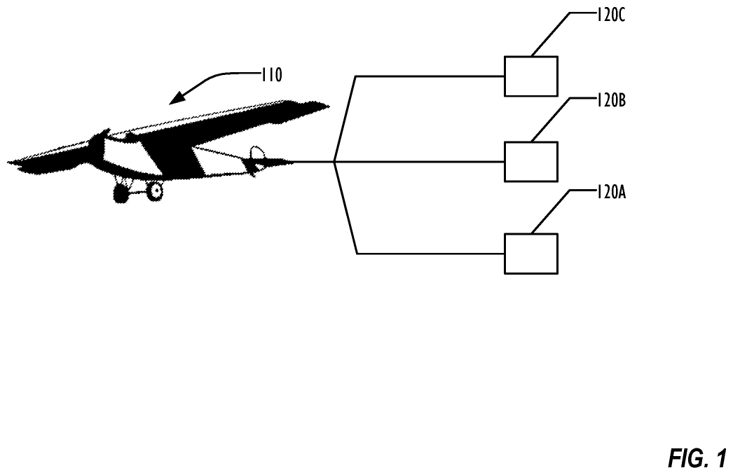

The remote sensing aircraft is configured for towing an array of remote sensing devices. Each of the remote sensing devices is an apparatus providing a mount for a remote sensing imaging sensor. Any type of remote sensing device can be used. For example, the sensor can be a forward-looking multispectral, hyperspectral, or thermal imaging system that includes a mid-wave infrared camera. Because the sensor is mounted on an apparatus that in operation is towed behind the remote sensing airplane, the sensor preferably includes image stabilization capabilities. One source of such cameras is FLIR Systems, Inc., which provides several models of thermal imaging camera systems for airborne usage. FIG. 1 is a block diagram illustrating an aircraft 110 towing an array of remote sensing devices 120A-C according to one embodiment. Although infrared camera systems are the typical type of remote sensing imaging sensor, other types of sensors can be used as desired. Additional sensors can be used, for example, charge-coupled devices, color daylight optics, low light imagers, and laser rangefinders.

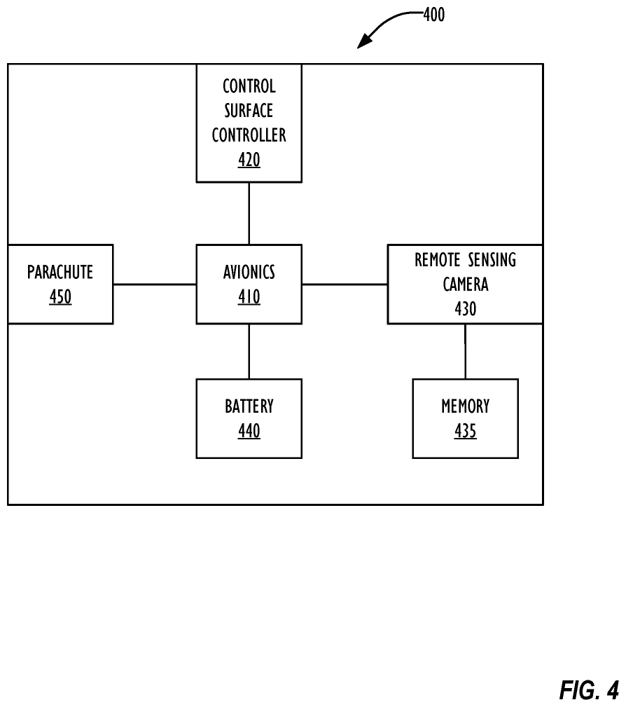

The remote sensing devices that comprise the array of remote sensing devices 120A-C are typically aerodynes but can be aerostats if desired. Each device 120 includes a sensor, including any power source required by the sensor, typically one or more batteries, as is described below in more detail in the discussion of FIG. 4. Typically, the remote sensing device 120 is considered unpowered, because its motive force is provided by the towing aircraft, even though it may contain a power source for the sensor. Thus, most remote sensing devices 120 are gliders. However, some or all of the array of remote sensing devices 120 can be powered aerodynes, such as powered drones. Preferably the remote sensing devices 120 comprise a fuselage for mounting the electronics for controlling the camera and other features and an airfoil providing lift when towed through the air. Although three remote sensing devices 120A-C comprise the array of remote sensing devices in FIG. 1, other numbers of remote sensing devices can be used as desired.

In addition to the sensor, each of the array of remote sensing devices is configured for lateral and vertical positioning. Each member of the array is configured so that when the array is towed behind the remote sensing aircraft, the members of the array do not collide with each other, but are spread out in a predetermined pattern. The lateral spacing of the members of the array can be configured so that the field of coverage of each sensor partially overlaps with the field of coverage of its neighbor sensors, with the overlap minimized to ensure the largest possible coverage area for the array of remote sensing devices as a whole. The lateral spacing may be achieved by the use of a rudder or other control surface attached to the glider's fuselage or wings in some embodiments. In embodiments using drones or other powered devices, they may be flown under power to a predetermined station-keeping position under the control of onboard avionics.

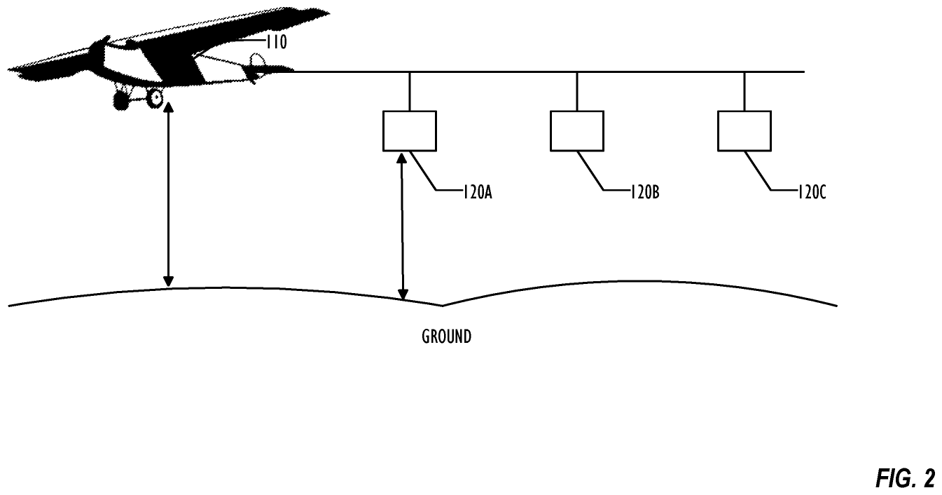

Vertical positioning of the members of the array of remote sensing devices can also be provided. For example, in one configuration, illustrated in FIG. 2, members of the array of remote sensing devices 120A-C can be configured for an altitude lower than that of the towing aircraft. In other configurations, members of the array of remote sensing devices can be configured for an altitude level with or higher than that of the towing aircraft. Different members of the array may be positioned at different relative altitudes if desired. The vertical positioning configuration is typically provided by setting the position of a control surface of an airfoil such as a flap, aileron, or flaperon.

Each member of the array of remote sensing devices may be configured individually, causing that member to position itself in the towed array in the correct position relative to the other members of the array. The control surface settings may be fixed and preset on the ground before the array is towed or may be individually controlled inflight, either by remote control from the remote sensing aircraft or by an onboard control system. In some embodiments, an active positioning system may be controlled by an onboard computer system, to provide enhanced station keeping of each member relative to each other member as air conditions change during flight.

Because members of the towed array of remote sensing devices may encounter problems inflight, such as accidental or deliberate severing of the towing connection, embodiments preferably include a safety feature that prevents a disconnected remote sensing device from becoming a missile that could endanger humans, wildlife, or property. In one embodiment, a parachute system can be provided in the fuselage of the remote sensing device that is triggered by disconnection of the towing connection or a predetermined deceleration caused by no longer being towed by the remote sensing aircraft. The parachute system deploys and brings the disconnected remote sensing device to a slow and safe descent. Even if the parachute system does not prevent the remote sensing device from being damaged during the landing, the parachute system reduces the speed of the remote sensing device and thus the likelihood of damage. If the towed remote sensing device is a powered device, instead of a parachute system the device can be flown to a safe landing site using an onboard control computer system.

Although some embodiments may provide real-time communication of sensor data from the members of the array of remote sensing devices to either an aircraft receiver system or a ground-based receiver, most embodiments provide onboard data storage that can be downloaded using wired or wireless connectivity once the towed array is landed.

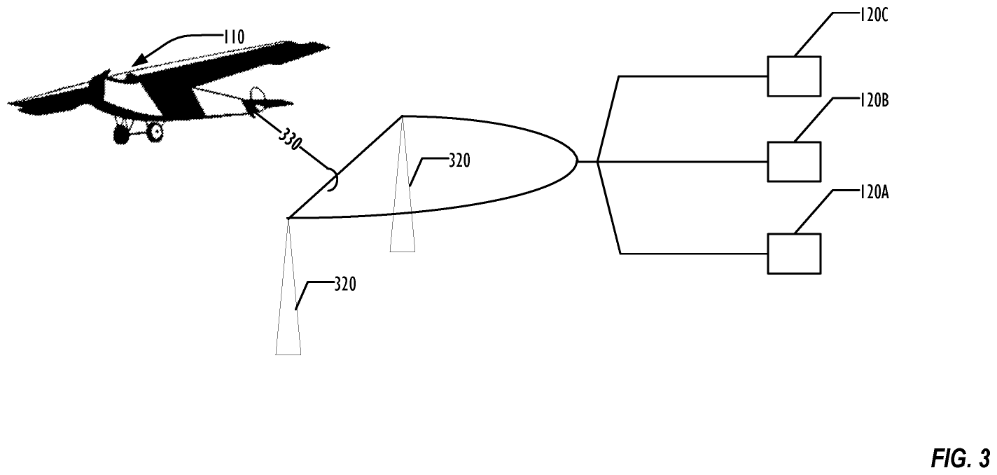

The array of remote sensing devices that is towed by the remote sensing aircraft is connected by cables to each other and laid out pre-flight on the ground. Similar to how aerial advertising pilots pick up a banner for towing behind the aerial advertising plane, the remote sensing aircraft takes off and then uses a hook 330 or similar apparatus trailing behind and below the plane to snag a pickup cable, as illustrated by FIG. 3. The pickup cable 310 is typically held above the ground on pylons 320 or other vertical supports. Once the pickup cable is snagged by the trailing hook, the remote sensing array will begin to be towed airborne. In some embodiments, the members of the array of remote sensing devices are individually connected via tow cables to a common tow point. In other embodiments, subarrays of remote sensing devices can be connected to a subarray connection point by individual tow cables, and the subarrays connection points are connected to the common connection point by tow cables. The cables connecting the array of remote sensing devices 120A-C can be of any desired length and are typically sized in part based on the predetermined inflight separation between the members of the array of remote sensing devices 120A-C.

During flight, the array of remote sensing devices spread out as configured into the predetermined separation and position pattern and begin recording information using the sensors of each remote sensing device. At the end of the flight, the aircraft can return to the takeoff airstrip and disengages from the towed array of remote sensing devices, which can then parachute or otherwise land for recovery of the devices and any data not transmitted during the flight.

FIG. 4 is a block diagram illustrating an electronics package 400 for a remote sensing device 120 according to one embodiment. An avionics processor 410 and related components can be used for controlling control surfaces of the remote sensing device 120 via control surfaces controls 420. Typically, the control surfaces controls 420 use mechanical connections, electrical motors, or hydraulics to control the control surfaces of the remote sensing device 120. A battery 440 provides power for the electronics package 400. An infrared camera 430 is controlled by the avionics processor 410 for performing the remote sensing. In some embodiments, the camera 430 is configured to capture images and store them in memory or storage device 435, such as a solid-state storage device. In embodiments configured with a parachute safety device, parachute controls 450 manage the deployment of the parachute under the control of the avionics processor 410. In some embodiments, transmitters on the remote sensing devices 120 may communicate with the camera 430 and transmit the captured images to receivers on the towing aircraft 110, which may then store sensing data, relay the data to a base station, or take other actions based on the sensed data. In other embodiments, the transmitters may communicate directly with a base station for further dissemination of the images for analysis.

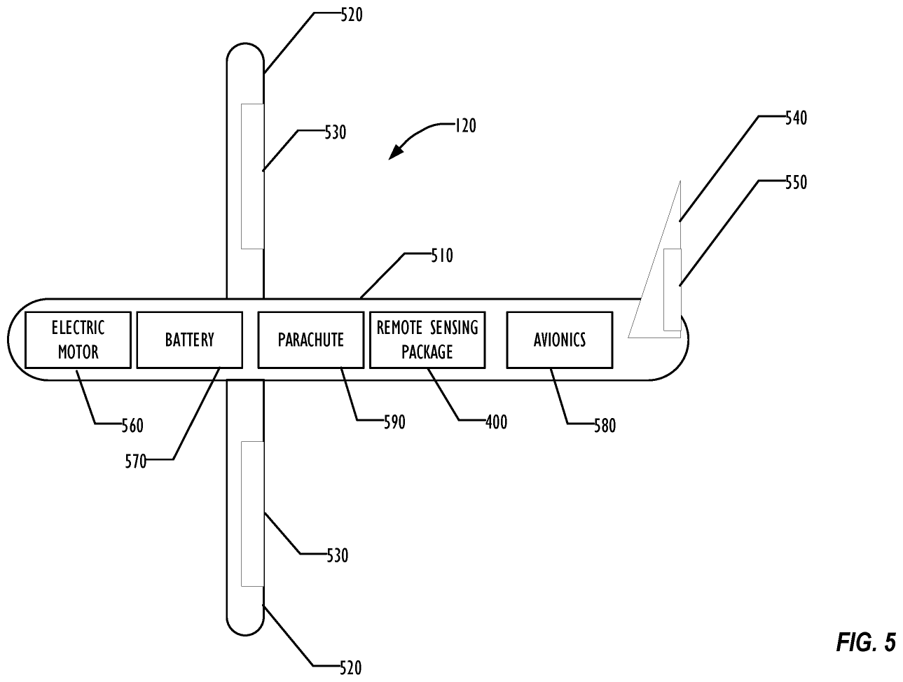

FIG. 5 is a block diagram of a remote sensing device 120 according to one embodiment. The remote sensing device 120 is typically in the form of an aircraft having a fuselage 510, in which the electronics package 400 of FIG. 4 is installed. Airfoils 520 in the form of wings may provide lift, and movable control surfaces 530 in the airfoils 520 may be used to control the flight of the remote sensing device 120. A rudder 550 disposed on a vertical stabilizer 540 may provide additional movable control surfaces. In some embodiments, the remote sensing device 120 may further include an electric motor 560 for powering the control surfaces 530 or rudder 550, as well as for providing motive power for a propeller (not shown) in a powered aircraft configuration. A battery 570 can provide power for the electric motor 560, as well as for the electronics package 400 and an avionics unit 580 that can provide control over the control surfaces 530 or rudder 550 and other inflight functions of the remote sensing device 120. For example, the avionics 580 may be capable of detecting separation from the towing aircraft 110 and triggering deployment of a parachute 590 or other landing system. Other conventional features of a aircraft, such as an undercarriage for takeoff and landing may be provided, but are omitted from FIG. 5 for clarity.

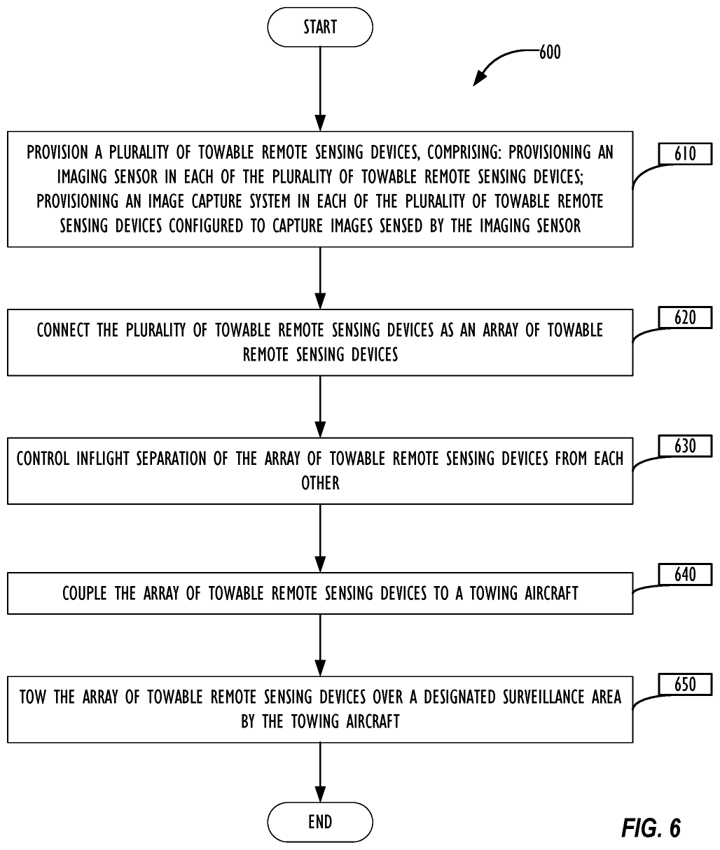

FIG. 6 is a flowchart of an example process for remote sensing. As shown in FIG. 6, process 600 may include provisioning a plurality of towable remote sensing devices, including: provisioning an imaging sensor in each of the plurality of towable remote sensing devices; and provisioning an image capture system in each of the plurality of towable remote sensing devices configured to capture images sensed by the imaging sensor (block 610). As also shown in FIG. 6, process 600 may include connecting the plurality of towable remote sensing devices as an array of towable remote sensing devices (block 620). As further shown in FIG. 6, process 600 may include controlling inflight separation of the array of towable remote sensing devices from each other (block 630). As also shown in FIG. 6, process 600 may include coupling the array of towable remote sensing devices to a towing aircraft (block 640). As further shown in FIG. 6, process 600 may include towing the array of towable remote sensing devices over a designated surveillance area by the towing aircraft (block 650).

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

By using a low-flying, relatively slow aircraft towing an array of remote sensing devices spread out laterally, a large coverage area can be covered in a single pass, reducing the cost and time required substantially over an aircraft with a single remote sensing device mounted on the aircraft or towed behind it. The coverage area can be significantly larger than any ground-based sensing technique, and requires fewer skilled operators, providing a major improvement in the field of remote sensing. The data collected by the remote sensing system can be analyzed for the detection of emissions such as methane leaks or other types of surveillance activity.

While certain exemplary embodiments have been described in detail and shown in the accompanying drawings, it is to be understood that such embodiments are merely illustrative of and not devised without departing from the basic scope thereof, which is determined by the claims that follow.

We claim:

1. A remote sensing system for towing by a towing aircraft, comprising:
an array of remote sensing devices, connected by cables, wherein each remote sensing device of the array of remote sensing devices comprises:
a fuselage;
an electronics package configured for remote sensing disposed with the fuselage, comprising:
an imaging sensor; and
means for capturing images sensed by the imaging sensor; and
means for controlling inflight positioning of each remote sensing device of the array of remote sensing devices; and
means for coupling the array of remote sensing devices to the towing aircraft.

2. The remote sensing system of claim 1, wherein each of the array of remote sensing devices is an aerodyne.

3. The remote sensing system of claim 1, wherein each of the array of remote sensing devices is an aerostat.

4. The remote sensing system of claim 1,
wherein each of the array of remote sensing devices further comprises an airfoil,
wherein the means for controlling inflight positioning of each remote sensing device of the array of remote sensing devices comprises one or more movable control surfaces of the airfoil, and
wherein the means for controlling inflight positioning of each remote sensing device of the array of remote sensing devices comprises avionics for controlling the one or more movable control surfaces of the airfoil for controlling vertical positioning of each remote sensing device of the array of remote sensing devices.

5. The remote sensing system of claim 1,
wherein each of the array of remote sensing devices further comprises a vertical stabilizer, and
wherein the means for controlling inflight positioning of each remote sensing device of the array of remote sensing devices comprises a rudder disposed on the vertical stabilizer for controlling lateral separation of each remote sensing device of the array of remote sensing devices from other remote sensing devices of the array of remote sensing devices.

6. The remote sensing system of claim 1, wherein the imaging sensor comprises a forward-looking mid-wave infrared camera.

7. The remote sensing system of claim 1, wherein the imaging sensor comprises a forward-looking multispectral camera.

8. The remote sensing system of claim 1, wherein each of the array of remote sensing devices is a powered drone.

9. The remote sensing system of claim 8,
wherein each of the array of remote sensing devices are flown under power to a predetermined station-keeping position relative to each other of the array of remote sensing devices, and
wherein the means for controlling inflight positioning of each remote sensing device of the array of remote sensing devices comprises onboard flight control avionics.

10. The remote sensing system of claim 1, wherein each of the array of remote sensing devices further comprises:
a parachute configured to deploy upon separation from the towing aircraft.

11. A method of remote sensing, comprising:
provisioning a plurality of towable remote sensing devices, comprising:
provisioning an imaging sensor in each of the plurality of towable remote sensing devices;
provisioning an image capture system in each of the plurality of towable remote sensing devices configured to capture images sensed by the imaging sensor;
connecting the plurality of towable remote sensing devices as an array of towable remote sensing devices;
controlling inflight positioning of the array of towable remote sensing devices;
coupling the array of towable remote sensing devices to a towing aircraft; and
towing the array of towable remote sensing devices over a designated surveillance area by the towing aircraft.

12. The method of claim 11, further comprising:
detecting separation of one of the array of towable remote sensing devices from the towing aircraft; and
deploying a parachute from the one of the array of towable remote sensing devices responsive to detecting separation.

13. The method of claim 11, wherein connecting the plurality of towable remote sensing devices as an array of towable remote sensing devices comprises connecting each of the plurality of towable remote sensing devices individually to a common tow point.

14. The method of claim 11, wherein controlling inflight positioning of the array of towable remote sensing devices comprises: controlling lateral separation of members of the array of towable remote sensing devices from each other in flight.

15. The method of claim 11, wherein controlling inflight positioning of the array of towable remote sensing devices comprises: controlling vertical positioning of members of the array of towable remote sensing devices.

16. The method of claim 11, wherein installing an imaging sensor in each of the plurality of towable remote sensing devices comprises installing a forward-looking thermal imaging camera in each of the plurality of towable remote sensing devices.

17. The method of claim 11, wherein coupling the array of towable remote sensing devices to the towing aircraft comprises:
connecting the array of towable remote sensing devices to a pickup cable; and
snagging the pickup cable by a trailing hook of the towing aircraft.

18. The method of claim 11, wherein controlling inflight positioning of the array of towable remote sensing devices comprises controlling control surfaces of each of the plurality of towable remote sensing devices by onboard avionics.

19. The method of claim 11, further comprising transmitting in flight captured remote sensing images from the array of towable remote sensing devices to the towing aircraft.

20. The method of claim 11, wherein provisioning the image capture system in each of the plurality of towable remote sensing devices configured to capture images sensed by the imaging sensor comprises provisioning a storage device connected to the imaging sensor.
